(19) United States
(12) Patent Application Publication
(10) Pub. No.: US 2008/0177746 A1
(43) Pub. Date: Jul. 24, 2008

(54) CASH BACK TRACKER / BROWSER REDIRECTING SYSTEM

(76) Inventor: Marat Borin, San Antonio, TX (US)

Correspondence Address: M. Borin, 619 Ridge Trace, San Antonio, TX, 78258, US

(21) Appl. No.: 11/626,052

(22) Filed: Jan. 23, 2007

(51) Int. Cl. G06F 17/30

(52) U.S. Cl. 707/10

(57) ABSTRACT

A tracking software that monitors Internet browser's address window for URLs and compares them to it's database. If there's a match then the browser is redirected to a corresponding URL in it's database. Software will only redirect once per browser session to prevent looping. When a user navigates to a website and then redirected by the software an alert window will display on the computer's monitor notifying the user of the potential percentage amount of cash back they will be receiving from shopping on that web site. The software will then record all shopping activity for this user and store it on a remote web server under the user's account for accounting purposes.

### FIELD OF THE INVENTION

The present invention relates to Internet and, more particularly, to websites that offer cash back rebates to their users.

### BACKGROUND OF THE INVENTION

Currently there is no known method for tracking user's purchases on various e-commerce website and record their spending in order to give cash back rebates without the use of hyper text linking. The current method requires the user to navigate to the destination e-commerce website from the cash back provider's website by clicking on a link.

It is an object of this invention to provide an improved and efficient method of redirecting users from one website to another automatically without the need of clicking on any links. Further more it is an object of this invention to efficiently track it's users' commissions from purchases made by user on e-commerce websites.

### SUMMARY OF THE INVENTION

In accordance with the present invention, there is provided a system that will allow websites to automatically, and without the website operators involvement, redirect their visitors and members to any website (URL). This software will be PC based and will require for the user to install it on their PC's hard drive.

Examples of uses:

1) This system can be used by a website that pays it's members a cash back rebate for shopping on other websites without the use of cookies that can be disabled on a user's browser. When activated, this software monitors the user's browser for certain domain addresses. If a domain address is matched with a database then this software will automatically redirect the browser to the a correct destination URL (Uniform Resource Locator), a URL that's specifically designed to track the user's purchases.

### BRIEF DESCRIPTION OF THE DRAWINGS

A complete understanding of the present invention may be obtained by reference to the accompanying drawings, when considered in conjunction with the subsequent, detailed description, in which:

FIG. 1 Basic operation

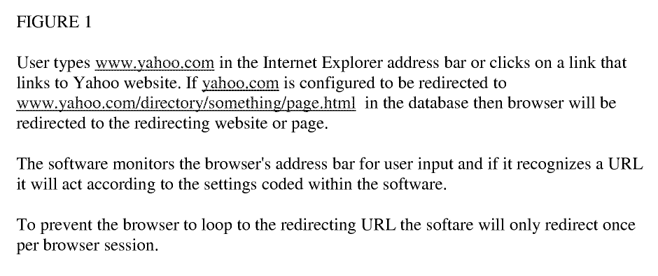

For purposes of clarity and brevity, like elements and components will bear the same designations and numbering throughout the FIGURES.

### DESCRIPTION OF THE PREFERRED EMBODIMENT

This URL Redirecting System is software based and can be written (coded) in various computer languages such as C+, VB, or similar. The software is comprised of several elements, most important of which is a database of redirecting URL's and a mechanism of utilizing this database to monitor a browser for domain names, matching them up with information in the database, and then redirecting the browser to the destination URL. The main purpose of this software system is to enable providers of such software to redirect a user who is browsing the Internet to the correct website/URL without requiring the user to click on a text link or to physically type the correct URL in the browser address bar.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A software and method for automated browser redirection from one website (url) to another without the use of hyper links placed on a page of a website, comprising:
providing at least one client workstation and one network server coupled to said network environment, wherein said network environment is a Word Wide Web (www);
means for monitoring client's browser's URL destinations on the www.
means of connecting to a hosted database on a remote server.
means of downloading and saving database to client's computer.
means of comparing client's browser destination URL to URL database.
means of redirecting client's browser URL to URL in database.

2. The method of claim 1, wherein means for monitoring client's browser's URL destinations on the www comprising the steps of:
recognizing the browser's address bar status and the domain name of the website that the browser window has currently opened.

3. The method of claim 1, wherein said means of connecting to a database on a remote server comprising the steps of:
initiating a direct link to said database utilizing clients internet connection via www.

4. The method of claim 1, wherein said means of downloading and saving database to client's workstation comprising the steps of:
downloading the database to clients workstation and saving it to a folder on clients workstation; once downloaded the database will be encrypted so that the contents can not be understood by a human eye.

5. The method of claim 4, wherein said means of downloading and saving database to client's workstation comprising the steps of:
if an existing database is already found on the client's workstation then database will be compared and if there are no changes then nes database will not be saved.

6. The method of claim 1, wherein said means of comparing client's browser destination URL to URL database comprising the steps of:
software will look for and recognize the top level domain of the current website where the client's browser is navigating; this domain will be compared to the domain/url database for instructions on how to control the browser if there's a match.

7. The method of claim 1, wherein said means of redirecting client's browser URL to URL in database comprising the steps of:
if the database has instruction to redirect the browser's domain/URL to another URL the browser will be redirected accordingly; this will be done only once per browser session to avoid looping.
